(19) United States
(12) Patent Application Publication
(10) Pub. No.: US 2004/0205526 A1
(43) Pub. Date: Oct. 14, 2004

(54) Prompted form filling mechanism

(76) Inventors: Vadim Borodovski, Saint John (CA); Greg Parker, Quispamsis (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 09/965,899

(22) Filed: Sep. 28, 2001

(51) Int. Cl. G06F 17/24

(52) U.S. Cl. 715/505; 715/507

(57) ABSTRACT

A prompting form-fill mechanism is provided which interactively populates data fields on electronic forms or other documents from prestored data fields. The first data field to be populated is determined and hi-lighted, then a user selects a prestored data field to copy into the first data field. The form-fill mechanism then automatically copies the information from one data field to the other. After populating the first data field, the form-fill mechanism hi-lights the next data field to be populated. This procedure is continued until all data fields are populated.

### CROSS-REFERENCE TO RELATED APPLICATIONS

N/A

### STATEMENT REGARDING FEDERALLY SPONSORED RESEARCH OR DEVELOPMENT

N/A

### REFERENCE TO A SEQUENCE LISTING

N/A

### BACKGROUND OF THE INVENTION

The invention relates generally to answering questions found in electronic forms and more particularly to an apparatus and method for entering information into a registration form on the Internet.

Computer users are frequently required to respond to electronic forms with name, address, and/or other personal information. These forms are encountered when purchasing goods online, when subscribing to online services, when filling out registration information for new software, etc. Typically, these forms are presented in the user's browser window as part of a website the user has accessed. Since much of the information required by different forms is the same, people tend to become annoyed at the need to type the same information each time.

These forms tend to follow certain protocols, such as allowing the user to use the “tab” key on the keyboard to navigate through the blanks on the form. However, the layout or presentation of the questions is not standardized. For example, the name, address, and telephone number fields are frequently presented in different orders and require different responses. For example, in some forms, the name may inlude the “Full Name” as one field, while in other forms the name may be split into “First Name”, “Middle Initial”, and “Last Name” fields. Further, the phone number may not have a separate field for area code, etc.

Conventional software exists for providing the name and address information to these forms. Generally, this software transfers an entire “wallet” of information as a single piece of data to the online form. However, because of the differences in forms discussed above, information does not always get placed into the appropriate areas of the form. There has been a degree of success with known websites, such as popular online shopping sites, because the software has “learned” the correct formats for those sites. However, when a new form is encountered, the user is still required to type in the entries until the software learns how to handle that form.

Other conventional software employs a drag and drop capability that allows the information to be moved, one piece at a time, from the wallet to the form. However, this software provides no indication of the order for filling the form and thus the user must hunt for the desired information within the wallet then hunt again for where to place the information in the form.

Thus, it would be beneficial to provide a method of filling in a form, in which the determination of when to transfer information and which information to transfer remains with the user, and the number of mouse clicks and/or the amount of typing required to make the transfer is minimized. It would also be beneficial to provide prompts indicating the next requested piece of data.

### BRIEF SUMMARY OF THE INVENTION

An aspect of the invention provides a method of populating a data field in an electronic document. The method includes locating a data field to be populated in the document, then associating a visual indication with the data field. The method also includes providing a wallet capable of having multiple data fields. The method also includes populating the data field in the document with data from a data field in the wallet.

Another aspect of the invention provides an apparatus for populating a data field in an electronic document. The apparatus includes a locating module for locating a data field in the document. It also includes an indicating module for associating a visual indication with the data field. A wallet is included which is capable of having a plurality of data fields, and a populating module is included for populating the data field in the document with data from a data field in the wallet.

Still another aspect of the invention provides an apparatus for populating a data field in an electronic document. The apparatus includes a wallet capable of having a plurality of data fields, and software capable of indicating the data field and capable of copying data from at least one data field in the wallet to the data field in the electronic document.

Another aspect of the invention provides a method for populating a data field in an electronic document that includes populating at least one data field in a wallet with information. The method also includes locating an empty data field in an electronic document, visually indicating the empty data field, selecting the data field from the wallet and automatically populating the empty data field with the information from the data field in the wallet. The method further includes locating another empty data field in the electronic document and visually indicating the another empty data field.

The invention will next be described in connection with certain illustrated embodiments; however, it should be clear to those skilled in the art that various modifications, additions and subtractions can be made without departing from the spirit or scope of the claims.

### BRIEF DESCRIPTION OF THE SEVERAL VIEWS OF THE DRAWINGS

For a fuller understanding of the nature of the invention, reference should be made to the following detailed description and accompanying drawings, in which:

FIG. 1 is a block diagram illustrating an embodiment of the invention.

### DETAILED DESCRIPTION OF THE INVENTION

A prompting form-fill mechanism is provided which interactively populates data fields on electronic forms or other documents. Data fields include blank fields into which text may be entered, list boxes containing a selection of options, binary selections, mutually exclusive selections from a list, etc.

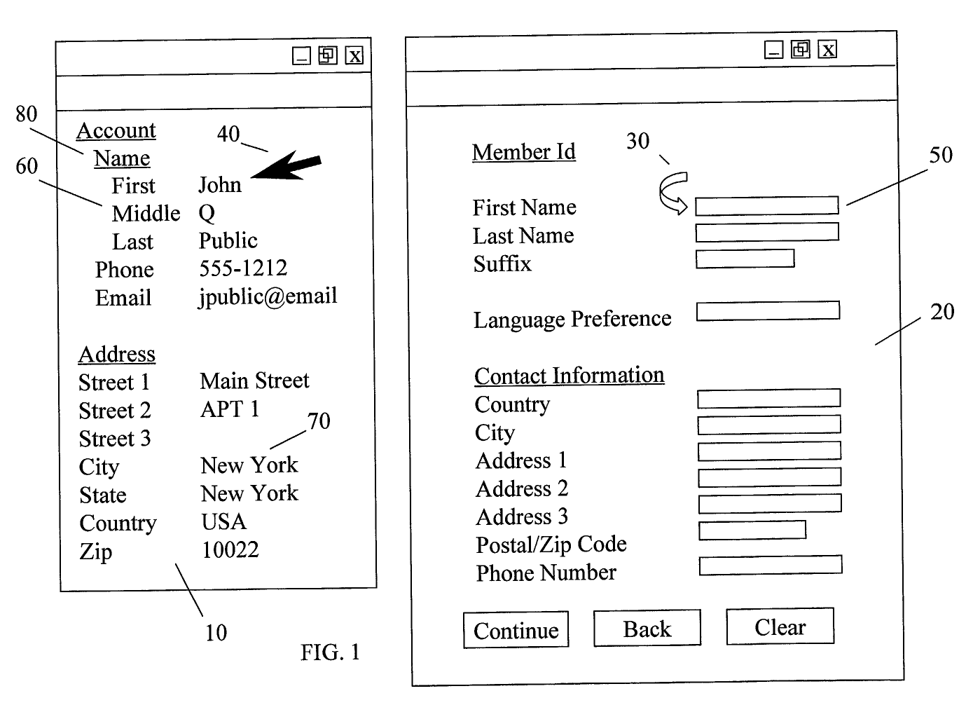

As FIG. 1 illustrates, the invention provides a wallet 10, for storing information that can be used to populate the data fields 50 in a registration form 20 on the Internet. While the following description will refer only to registration forms 20 being filled in (populated) via the Internet, those skilled in the art will recognize that the invention may be applied to any type of question that is normally answered using a computer. Some examples other than a registration form on the Internet include a survey on the Internet, a survey or registration form received via email, a registration form for software loaded onto a computer, a form downloaded from the Internet, etc. Further, while the description refers to computers and the Internet, the invention could also be applied to Personal Digital Assistants, pagers, phones, set top boxes, other networks, etc.

The wallet 10 is an electronic document that includes different data fields 70 of information. These data fields 70 could be preset data fields 70 such as first name, last name, etc., they could be data fields 70 that are determined by the user, or there could be a combination of user defined data fields 70 and default data fields 70. While it is possible to include duplicate information in different data fields 70 (e.g. have one field with the first name, e.g. “John”, and another field with the entire name, e.g. “John Doe”), it is preferable, but not required, to include multiple data fields 70, each with different information, that can be transferred alone or in groups. For example, rather than including the field Name (John Doe) it is preferable to have the fields First name (John) and Last name (Doe) and have the ability to transfer the information from each data field 70 separately (John or Doe) or together (John Doe). Such a grouping could be realized using a rule base (preset, user defined or a combination thereof), certain data fields 70 could be set up as a group 80 such that when the group 80 is selected every field 70 in that group 80 is transferred as a single entity, and/or the user could select multiple fields 70 by holding down the shift key (or some other selected key) and clicking multiple fields 70 with the mouse (or some other pointing device) to be grouped together, etc. The wallet 10 could display every data field 70 in one window, or the information could be separated into different views (e.g. delivery location and other location) such that when a user selects a particular heading, the data fields 70 associated with that heading could be displayed. Additionally, it may also be possible to select multiple data fields 70 and have them each be transferred to their respective destination data fields 50 if the data fields 50 and the data fields 70 are in the same order.

The wallet 10 may preferably be retrieved manually by calling the form-fill mechanism as any other program would be called, or the form-fill mechanism could run in the background and the wallet 10 could automatically pop-up when a blank data field 50 is detected (e.g. when a user clicks on the data field 50, when multiple blank data fields 50 are detected in a document, etc.). In either configuration, the wallet 10 is opened as a separate window so the information can be viewed, accessed and/or edited by the user.

The first field 50 on the form 20 to be populated is identified either by a mouse click, pointer or some other method, or the form-fill mechanism could default to the first field 50 on the form 20. Those skilled in the art will recognize that the form-fill mechanism could be configured to default to any field 50. For example, the default field could be the first field on the form, the second field, the last field, etc., or it could be a particular field such as the last name field, the first name field, the address field, etc. Once a field 50 is identified, or in conjunction with identifying the field 50, the form-fill mechanism visually marks the field 50 (e.g. with an arrow 30, with a star, by hi-lighting the field or any other method of visually indicating which field is to be populated). The form-fill mechanism may then draw from the wallet 10 to populate the empty field 50. The user selects a field 70 from the wallet 10 (e.g. by single or double clicking a mouse, pressing the return key, etc., on the field 70, the field name 60 or the group 80 to be transferred), and the data from that field 70 is transferred to the destination field 50. The mechanism then locates the next empty data field 50 in the destination document and prompts the user to identify the source for the next field 70, by presenting an arrow 30, cursor, or some other visual clue in the destination document. This process continues until all data fields are filled, all required data fields 50 are filled, or the user ends the process. Those skilled in the art will recognize that it may be possible, in certain instances, for the form-fill mechanism to compare the name of the selected data field 50 with the names of the data fields 70 in the wallet 10 and to visually mark the data field 70 that the form-fill mechanism determines to be the most probable data field 70 to be copied into the destination data field 50.

In an embodiment of the invention, the form-fill mechanism is designed to interact with a browser window (although it could also be designed to operate with other types of applications). In operation, the form-fill mechanism determines the type of browser being employed.

For older browser versions, the form-fill mechanism copies the text to be transferred to the clipboard, and then simulates a paste operation in the target browser window. The form-fill mechanism then simulates a tab by copying a tab to the clipboard, and then simulating a paste operation on the browser window.

For newer browser versions, the form-fill mechanism queries the browser for an interface to its object model. Through this interface, the form-fill mechanism can determine the element that currently has input focus on the page. Using a handle to the element, the form-fill mechanism can change the element's inner text property to match that of the text being transferred. After transferring the information, the form-fill mechanism sets the input focus to the next element on the form.

It will be understood that changes may be made in the above construction and in the foregoing sequences of operation without departing from the scope of the invention. It is accordingly intended that all matter contained in the above description or shown in the accompanying drawings be interpreted as illustrative rather than in a limiting sense.

It is also to be understood that the following claims are intended to cover all of the generic and specific features of the invention as described herein, and all statements of the scope of the invention which, as a matter of language, might be said to fall therebetween.

Having described the invention, what is claimed as new and secured by Letters Patent is:

1. A method of populating a data field in an electronic document comprising:
locating a data field in the document to be populated;
associating a visual indication with the data field;
providing a wallet capable of having a plurality of data fields; and,
populating the data field in the document with data from a data field in the wallet.

2. The method according to claim 1 further comprising:
subsequent to populating the data field, determining if another data field exists that may be populated;
locating the another data field to be populated; and,
associating the visual indication with the another data field.

3. The method according to claim 2 further comprising:
populating the another data field with data from another data field in the wallet.

4. The method according to claim 1 μfurther comprising:
associating another visual indication with the data field in the wallet.

5. The method according to claim 1 wherein said associating a visual indication includes placing one of an arrow, a star, a lightning bolt, a cursor and a dot next to the data field.

6. The method according to claim 1 wherein said associating a visual indication includes hi-lighting the data field.

7. Apparatus for populating a data field in an electronic document comprising:
locating means for locating a data field in the document to be populated;
indicating means for associating a visual indication with the data field;
a wallet capable of having a plurality of data fields; and,
populating means for populating the data field in the document with data from a data field in the wallet.

8. The apparatus according to claim 7 wherein:
the locating means is configured to locate another data field to be populated; and,
the indicating means is configured to associate the visual indication with the another data field.

9. The apparatus according to claim 8 wherein:
the populating means is also configured to populating the another data field with data from another data field in the wallet.

10. The apparatus according to claim 7, wherein,
the indicating means is also configured to associate another visual indication with the data field in the wallet.

11. The method according to claim 7 wherein said indicating means is configured to place one of an arrow, a star, a lightning bolt, a cursor and a dot next to the data field.

12. The method according to claim 7 wherein said indicating means is configured to hi-light the data field.

13. Apparatus for populating a data field in an electronic document comprising:
a wallet capable of having a plurality of data fields; and,
software capable of visually indicating the data field in the electronic document and of copying data from at least one data field in the wallet to the data field in the electronic document.

14. The apparatus according to claim 13, wherein said software is further capable of locating another data field in the electronic document and indicating the another data field.

15. A method for populating a data field in an electronic document comprising:
populating at least one data field in a wallet with information;
locating an empty data field in an electronic document;
visually indicating the empty data field;
selecting the at least one data field from the wallet;
automatically populating the empty data field with the information from the at least one data field;
locating another empty data field in the electronic document; and,
visually indicating the another empty data field.
